(19) United States
(12) Patent Application Publication
(10) Pub. No.: US 2013/0317920 A1
(43) Pub. Date: Nov. 28, 2013

(54) ORDERING TERMINAL AND ORDERING METHOD

(71) Applicant: TOSHIBA TEC KABUSHIKI KAISHA, Tokyo (JP)

(72) Inventor: Kenya Suzuki, Shizuoka-ken (JP)

(73) Assignee: TOSHIBA TEC KABUSHIKI KAISHA, Tokyo (JP)

(21) Appl. No.: 13/895,531

(22) Filed: May 16, 2013

(30) Foreign Application Priority Data
May 23, 2012 (JP) 2012-117694

(51) Int. Cl. G06Q 50/12

(52) U.S. Cl. CPC G06Q 50/12; G06Q 30/0631
USPC 705/15

(57) ABSTRACT

An ordering terminal comprises an image capturing unit, an attribute confirming unit, a menu confirming unit, a displaying unit, an operating unit and an ordering processing unit. The image capturing unit captures the image of an operator to generate image data. The attribute confirming unit confirms the attribute of the operator based on an operator image included in the image data. The menu confirming unit confirms a recommended menu specified for the attribute confirmed by the attribute confirming unit from a database specifying the recommended menu for each attribute of the operator. The displaying unit displays an ordering screen including a screen component for designating the recommended menu. The operating unit operates the ordering screen. The ordering processing unit carries out ordering processing on the menu designated by the operation of the ordering screen.

### CROSS-REFERENCE TO RELATED APPLICATION

This application is based upon and claims the benefit of priority from Japanese Patent Application No. 2012-117694, filed May 23, 2012, the entire contents of which are incorporated herein by reference.

### FIELD

Embodiments described herein relate to an ordering terminal for ordering a menu item and a method.

### BACKGROUND

In recent years, in a restaurant, an ordering terminal for ordering a menu item by the operation of a customer himself is utilized.

The ordering terminal, for example, displays an ordering screen equipped with a button for designating the menu item and ordering quantity, and sends the identification information of the menu item, the ordering quantity and the like, which are designated by the operation of the ordering screen, to superior equipment such as a server and the like.

It tries to increase sale by promoting the ordering of the recommended menu through displaying the information related to the menu item (hereinafter, called as recommended menu) recommended to the customer on the ordering screen of such an ordering terminal. Generally, the recommended menu is a preset fixed menu item.

The penchant of customers is different according to an attribute such as the age, the gender and the like of the customer, and in addition, according to a time period. Therefore, if the recommended menu is fixed as the preset menu item, the menu item according to the penchant of the customer cannot be recommended, and the sufficient effect cannot be acquired possibly.

### BRIEF DESCRIPTION OF THE DRAWINGS

FIG. 1 is a sketchy configuration diagram of an order entry system including an ordering terminal of a first embodiment;

FIG. 2 is a block diagram illustrating main portion configurations of a server of the first embodiment;

FIG. 3 is a block diagram illustrating main portion configurations of the ordering terminal of the first embodiment;

FIG. 4 is a diagram illustrating an example of an ordering screen of the first embodiment;

FIG. 5 is a diagram illustrating a data structure example of a recommending file (time period T1) of the first embodiment;

FIG. 6 is a diagram illustrating a data structure example of a recommending file (time period T2) of the first embodiment;

FIG. 7 is a diagram illustrating a data structure example of a totalizing file (time period T1) of the first embodiment;

FIG. 8 is a diagram illustrating a data structure example of a totalizing file (time period T2) of the first embodiment;

FIG. 9 is a flow chart of the processing executed by a CPU of the ordering terminal of the first embedment;

FIG. 10 is a flow chart of the processing executed by a CPU of the server of the first embedment.

### DETAILED DESCRIPTION

According to one embodiment, an ordering terminal comprises an image capturing unit, an attribute confirming unit, a menu confirming unit, a displaying unit, an operating unit and an ordering processing unit.

The image capturing unit captures the image of an operator to generate image data. The attribute confirming unit confirms the attribute of the operator based on an operator image included in the image data generated by the image capturing unit. The menu confirming unit confirms a recommended menu specified for the attribute confirmed by the attribute confirming unit from a database specifying the recommended menu for each attribute of the operator. The displaying unit displays an ordering screen including a screen component for designating the recommended menu confirmed by the menu confirming unit. The operating unit operates the ordering screen. The ordering processing unit carries out ordering processing on the menu designated by the operation of the ordering screen by the operating unit.

The embodiment is described below with reference to accompanying drawings.

### A First Embodiment

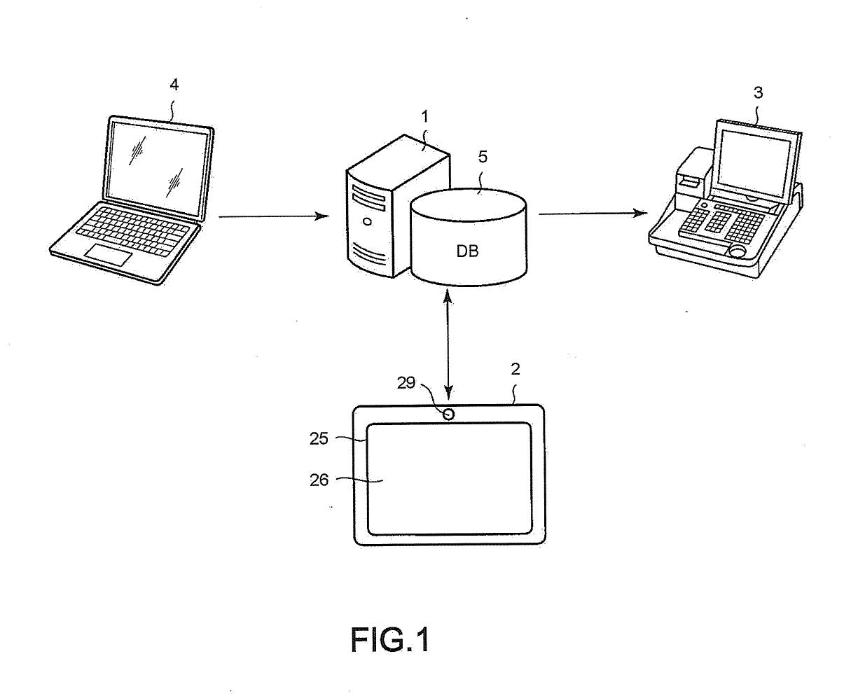

FIG. 1 is a sketchy configuration diagram of an order entry system including the ordering terminal of the first embodiment. The order entry system comprising a server 1 or a plurality of ordering terminals 2, a POS (Point Of Sales) terminal 3 and a setting-orientated PC 4 is used in a restaurant or a pub.

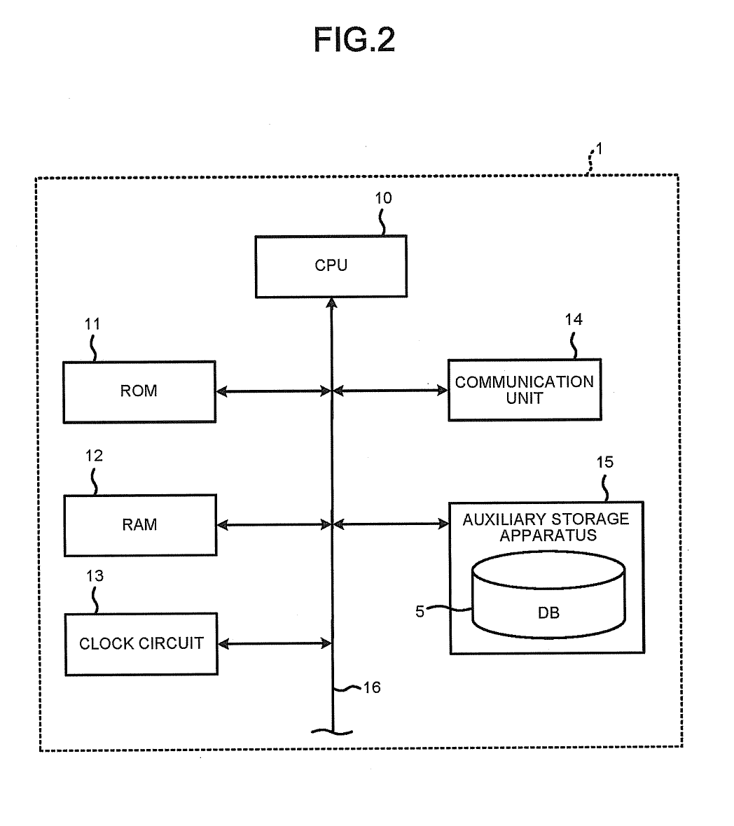

The server 1, for example, is configured in an office room of the food and drink shop. FIG. 2 is a block diagram illustrating main portion configurations of the server 1. The server 1 comprises a CPU (Central Processing Unit) 10, an ROM (Read Only Memory) 11, an RAM (Random Access Memory) 12, a clock circuit 13, a communication unit 14 and an auxiliary storage apparatus 15. The ROM 11, the RAM 12, the clock circuit 13, the communication unit 14 and the auxiliary storage apparatus 15 are connected with the CPU 10 by a bus line 16 consisting of an address bus and a data bus.

The ROM 11 stores fixed data of such as a computer program and the like executed by the CPU 10. The RAM 12 functions as a main storage apparatus of the server 1. The clock circuit 13 carries out timing on a time and a date by using units of, for example, a year, a month, a day, an hour, a minute and a second.

The communication unit 14 carries out communication with each element such as the ordering terminal 2, the POS terminal 3, the setting-orientated PC 4 and the like included in the order entry system by wire communication through an LAN (Local Area Network) cable or wireless communication through an electric wave and the like. For example, in the condition that the communication carried out with the ordering terminal 2 is the wireless communication, connect an access point for the wireless communication with the communication unit 14, and establish the wireless communication with the server 1 and the ordering terminal 2 through the access point and then it will be fine.

The auxiliary storage apparatus 15 can make use of, for example, a high-capacity storage apparatus such as an HDD (Hard Disk Drive) or an SDD (Solid State Drive), and the like. The auxiliary storage apparatus 15, for example, stores the database (DB) 5 and the like managing data related to an OS (Operating System), and various applications and the like, and data related to the recommended menu.

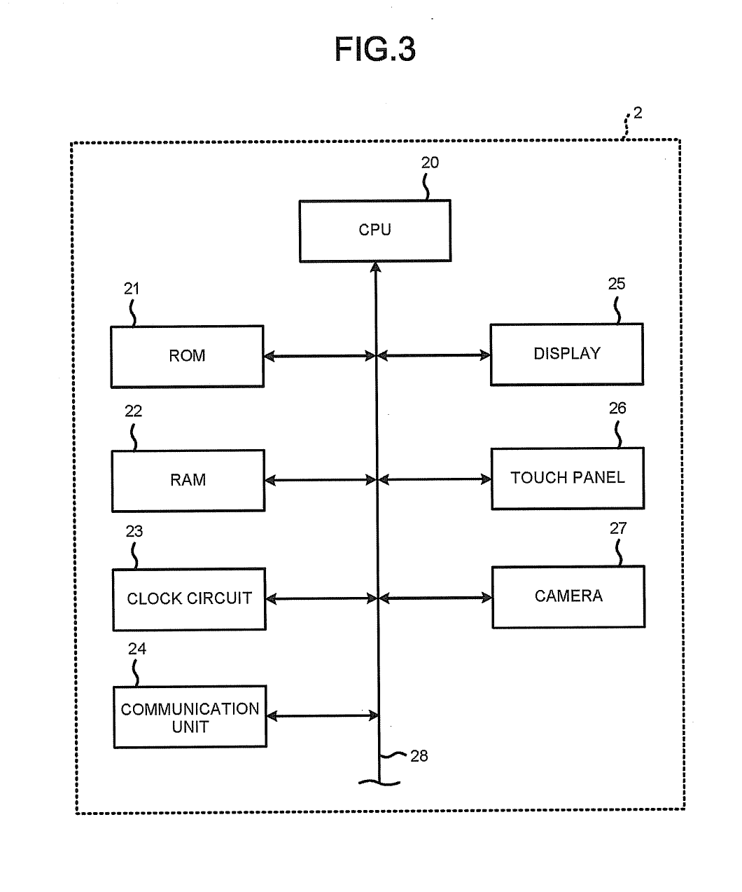

The ordering terminal 2 accepts the ordering carried out from the menu item provided in the food and drink shop by the operation of a customer himself. FIG. 3 is a block diagram illustrating main portion configurations of the ordering terminal 2. The ordering terminal 2 comprises a CPU 20, an ROM 21, an RAM 22, a clock circuit 23, a communication unit 24, a display 25, a touch panel 26 and a camera 27. The ROM 21, the RAM 22, the clock circuit 23, the communication unit 24, the display 25, the touch panel 26 and the camera 27 are connected with the CPU 20 through a bus line 28 consisting of the address bus and the data bus. The display 25 functions as the displaying unit of the present embedment, and the touch panel 26 functions as the operation unit of the present embodiment.

The ROM 21 stores the fixed data of such as a computer program and the like executed by the CPU 20. The RAM 22 functions as a main storage apparatus of the ordering terminal 2. The clock circuit 23 carries out the timing on the date and the time by using the units of, for example, the year, the month, the day, the hour, the minute and the second.

The communication unit 24 carries out the communication with the server 1 by the wire communication through the LAN cable or the wireless communication through the electric wave and the like. Particularly, in the condition that the access point is used as described above, the communication unit 24 carries out the wireless communication with the access point through the electric wave and the like.

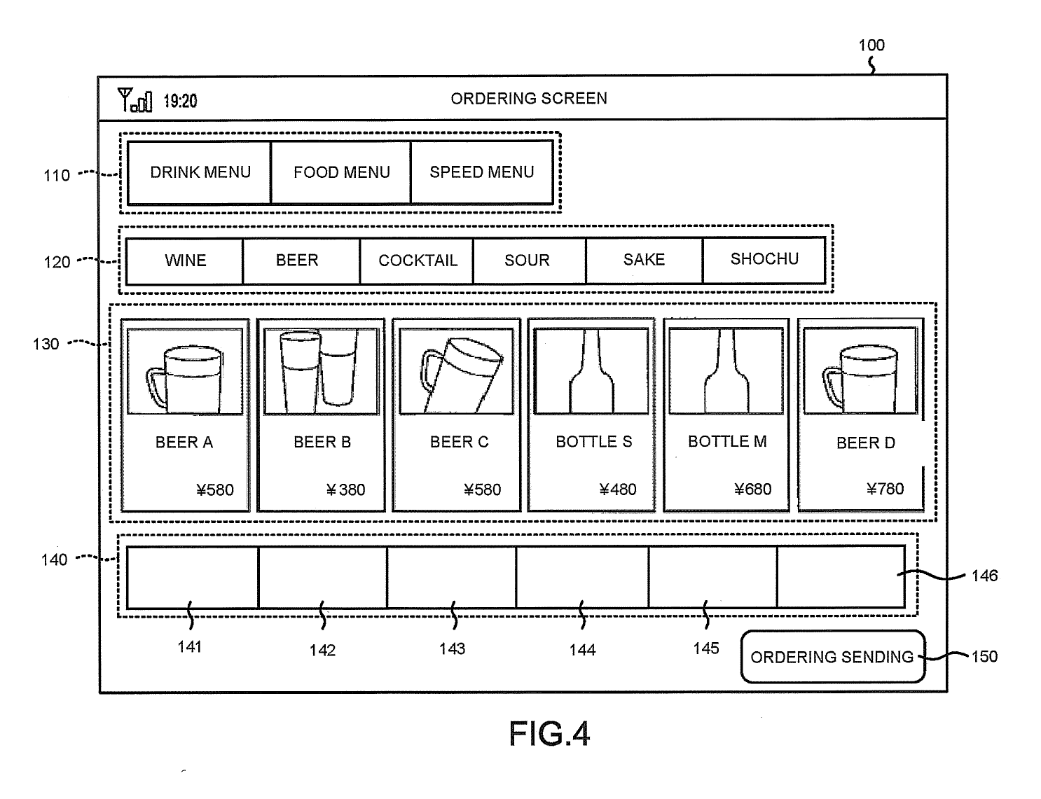

The display 25, for example, is an LCD (Liquid Crystal Display), displays the following ordering screen (referring to FIG. 4) and the like. The touch panel 26 which is arranged on a displaying screen of the display 25, detects a touch operation on the screen component (GUI: Graphical User Interface) which is included in the ordering screen and the like by a finger or a stylus and the like.

As shown in FIG. 1, a lens 29 condensing light from an image capturing area arranged along the displaying direction of the display 25 is arranged on the framework surface of the ordering terminal 2. The camera 27 comprises an image capturing element, for example, a CCD (Charge Coupled Device) outputting an electric signal corresponding to incident light, a reflecting mirror guiding the light converged by the lens 29 to the image capturing element, and an AD converter converting the electric signal output by the image capturing element into digital data. The camera 27 stores the data output from the AD converter, namely, the image data obtained by capturing the image of the image capturing area, in the RAM 22. The image capturing area mentioned above is positioned such that the face of a person operating the display 25 included in the image capturing area. Such setting, for example, can be carried out by adjusting the orientation and the focal distance of the lens 29. In addition, the camera 27 and the lens 29 constitute the image capturing unit of the present embodiment.

The ordering terminal 2, for example, is assembled and disassembled for a cradle arranged on or near a table in the food and drink shop. When the ordering terminal 2 is mounted on the cradle, power is supplied to the ordering terminal 2 from the cradle, and thus, a battery of the ordering terminal 2, which is not shown in figures, is charged. When carrying out the ordering, the customer captures the ordering terminal 2 down from the cradle, operates the ordering screen by using the finger or the stylus to carry out the ordering of the menu item.

The POS terminal 3 carries out the processing of calculating the cost of the menu item consumed by the customer. In the processing, the POS terminal 3 carries out the communication with the server 1 to acquire the information relating to the menu item consumed by the customer, accepts the payment of a total payment amount calculated based on the information, and then issues a receipt.

The setting-orientated PC 4 is a personal computer for carrying out various settings and the like on the server 1. An administrator of the order entry system, for example, can edit or read the data stored in the database 5 by the operation of a keyboard or a mouse the setting-orientated PC 4 comprises.

An example of the ordering screen displayed on the display 25 is illustrated in FIG. 4. The ordering screen 100 includes category button groups 110 and 120, a menu button group 130, a recommended menu button group 140 and an ordering sending button 150.

The category button group 110 consists of buttons for designating the categories of big classifications, such as a “drink menu”, a “food menu”, a “speed menu” and the like. On each button included in the category button group 110, the name and the like of the category of the big classification corresponding are shown.

The category button group 120 consists of buttons for designating the categories of small classifications included in the categories of the big classifications corresponding to the buttons operated by a user in the buttons included in the category button group 110. Namely, the buttons included in the category button group 120 can be switched according to the operations of the buttons included in the category button group 110. On each button included in the category button group 120, the name and the like of the category of the small classification corresponding to each button are shown. In FIG. 4, an example that the button of “drink menu” in the category button group 110 is pressed and the buttons for designating the category of the small classification such as “wine”, “beer”, “cocktail” and the like included in the “drink menu” are configured in the category button group 120, is illustrated.

The menu button group 130 consists of buttons for designating the menu item included in the category of the small classification corresponding to the button operated by the user in the button included in the category button group 120 as the ordering menu. Namely, the buttons included in the menu button group 130 can be switched according to the operation of the buttons included in the category button group 120. On each button included in the menu button group 130, the image, the name, the price and the like of the menu item corresponding to each button are shown. In FIG. 4, an example that the button to which the “beer” relates is operated by using the category button group 120, so that the button for designating the menu item such as “Draft beer Middle-jug”, “Draft beer Glass”, “Black-draft beer Middle-jug” and the like included in the “beer” is configured in the category button group 110, is illustrated.

The recommended menu button group 140 consists of buttons 141, 142, 143, 144, 145 and 146 for designating the recommended menu, namely, a menu item recommended to the customer as the ordering menu. However, the recommended menu button group 140 can be also constituted by using more or less buttons. A graphical representation is omitted in FIG. 4, but on the buttons 141-146 included in the recommended menu button group 140, the image or the name and the like of the menu items corresponding to the buttons 141-146 are shown.

The ordering sending button 150 is a button for confirming the ordering of the menu item designated by the operation for the button included in the menu button group 130 or the recommended menu button group 140.

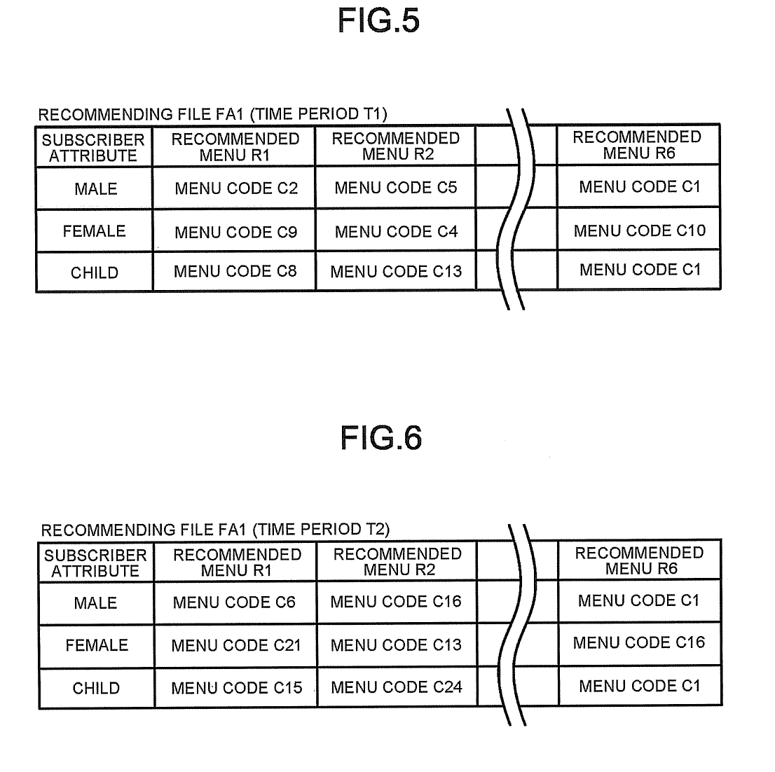

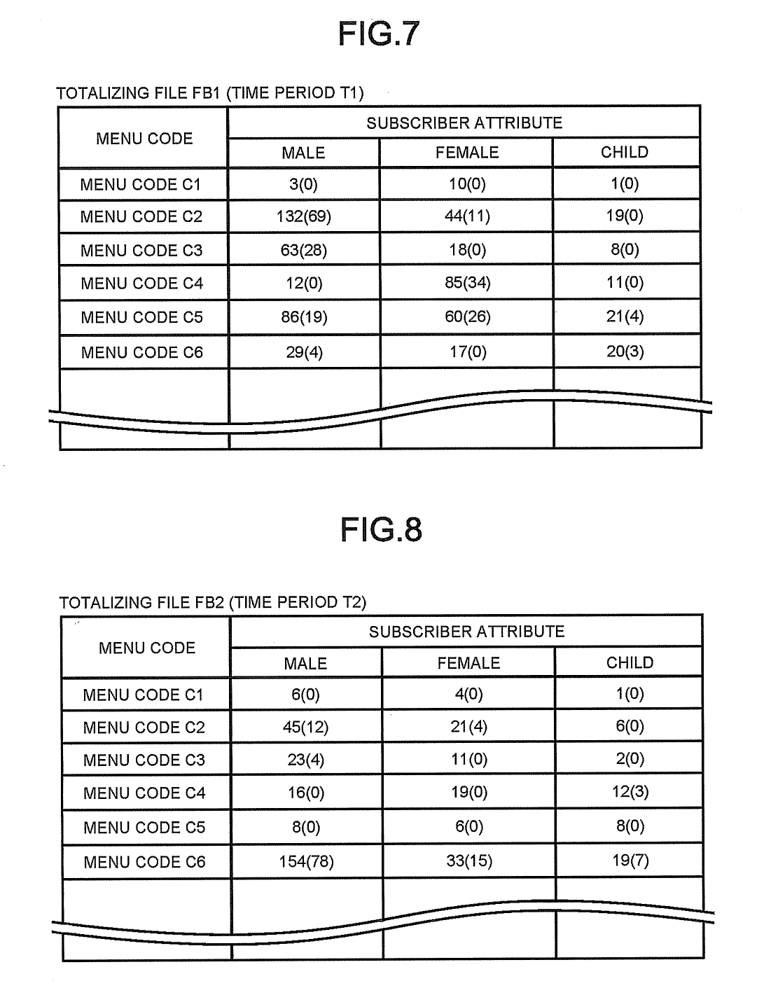

Next, the database 5 is described. The database 5 includes a recommending file FA1 with a data structure shown in FIG. 5, a recommending file FA2 with a data structure shown in FIG. 6, a totalizing file FB1 with a data structure shown in FIG. 7, and a totalizing file FB2 with a data structure shown in FIG. 8.

The recommending file FA1 is a file for specifying the recommended menu recommended to the customer for each subscriber attribute in a time period T1.

The recommending file FA2 is a file for specifying the recommended menu recommended to the customer for each subscriber attribute in a time period T2.

The attribute of a subscriber distinguishes the customers according to, for example, an age and a gender, and in the present embodiment, the attributes of the subscribers adopt three patterns of male, female and child.

Specifically, the recommending files FA1 and FA2 both have records (each row in FIG. 5 and FIG. 6) corresponding to each of the male, the female and the child. In each record, menu codes as six recommended menus R1, R2, R3, R4, R5 and R6 and for identifying the menu item are written.

In the present embodiment, the time periods T1 and T2 are set as time periods dividing the shop hours of a shop into a plurality of ones. Specifically, the time period T1 is set as a lunch time (for example, from shop opening to 3 p.m.), and the time period T2 is set as a dinner time (for example, from 3 p.m. to shop closure).

The totalizing file FB1 is a file for carrying out the totalization on an ordering quantity (hereinafter, called as total ordering quantity X) generated by the operations for the menu button group 130 and the menu button group 140 and the ordering quantity (hereinafter, called as recommended ordering quantity Y) generated by the operations for the buttons 141-146 included in the recommended menu button group 140 in the total ordering quantity X for each menu item provided in the food and drink shop in the time period T1 and each combination of the attributes.

The totalizing file FB2 is a file for carrying out the totalization on the total ordering quantity X generated by the operations for the menu button group 130 and the menu button group 140 and the recommended ordering quantity Y generated by the operations for the buttons 141-146 included in the recommended menu button group 140 in the total ordering quantity X for each menu item provided in the food and drink shop in the time period T2 and each combination of the attributes.

Specifically, the totalizing files FB1 and FB2 both have the records (each row in FIG. 7 and FIG. 8) set for each menu code. In each record, the total ordering quantity X and the recommended ordering quantity Y are written in for each of the male, the female and the child. In FIG. 7 and FIG. 8, like “X (Y)”, the recommended ordering quantity Y is expressed by being enclosed by using brackets, and the total ordering quantity X is shown on the left side of the recommended ordering quantity Y.

The main actions of the ordering terminal 2 are described.

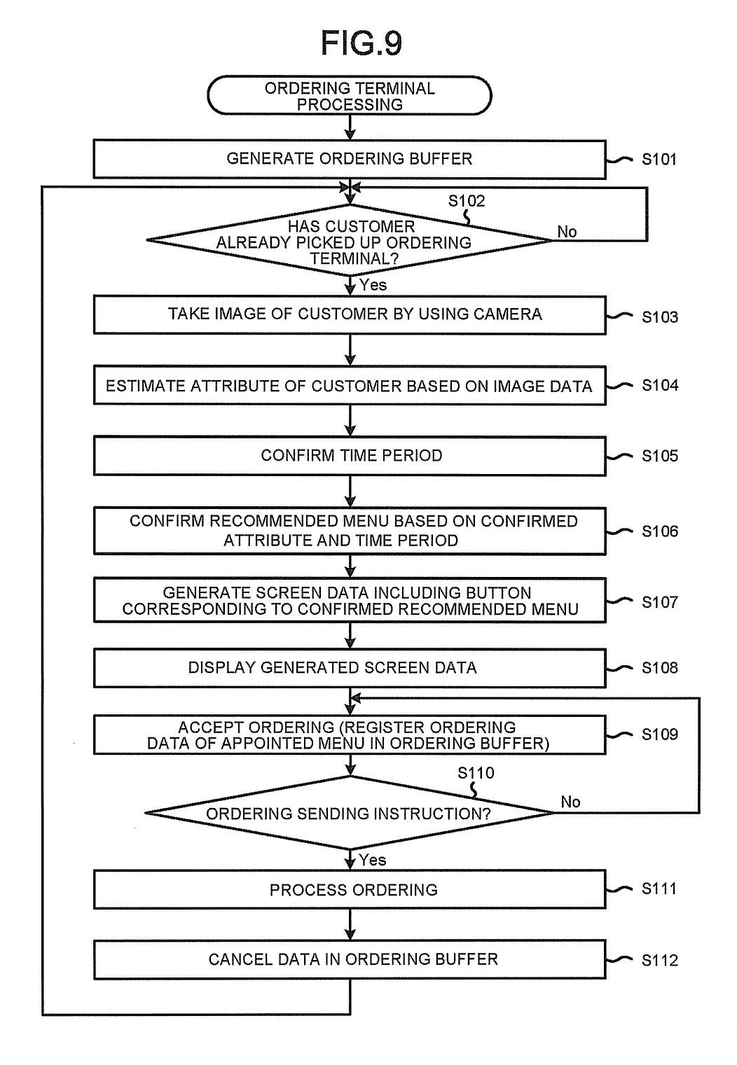

When the ordering terminal 2 is started up by the operation and the like of a power switch not shown in the figures, the CPU 20 of the ordering terminal 2 executes the computer program stored in the ROM 21 and the like, and begins acting according to a flow chart in FIG. 9.

In these actions, first, the CPU 20 forms an ordering buffer in RAM 22 for temporarily storing the information relating to the ordered menu item (Act S101). Afterwards, the CPU 20 waits until the customer picks up the ordering terminal 2 (Act S102).

In order to order the expected menu item, the customer coming in the food and drink shop and capturing a seat in the front of the table will pick up the ordering terminal 2 from the cradle configured on the table. At the moment, the power supply from the cradle to the ordering terminal 2 is cut off. Basing on the cutoff of the power supply from the cradle, the CPU 20 judges that the customer has picked up the ordering terminal (in Act S102, Yes) and gives out an instruction of capturing the image to the camera 27 (Act S103). The camera 27 receiving the instruction captures the image of the image capturing area and stores the image data acquired by capturing the image in the RAM 22. Generally, as the customer picking up the ordering terminal 2 will look at the screen of the display 25, the operator image including the face of the customer will be included in the image data.

After Act S103, the CPU 20 confirms the attribute of the customer, namely, the operator, basing on the image data stored in the RAM 22 (Act S104). Specially, in the present embodiment, the category of the male/female/child is confirmed as the attribute of the operator. As a method for confirming the attribute of the operator, for example, a face identification technology can be utilized. In addition, the attribute of the operator can be also judged by not only the face, but also the characteristics of cloth and the like.

In the condition that the face identification technology is utilized, for example, face image data of different genders are collected in advance, the relativity among the shapes and the position relationships of parts (head profile, eyes, nose, mouth, eyebrows, ears, hairline (hairline) of hair, wrinkles and the like) included in the collected face image data and each attribute is determined by utilizing a statistical method, and the data denoting a result is subjected to database formation to be previously stored in the ROM 21 and the like. Afterwards, the attribute of the operator is confirmed (estimated) by comparing the shapes, the position relations and the like of the parts mentioned above in the operator image included in the image data stored in the RAM 22 in Act S103 with the data stored in the database.

After Act S104, the CPU 20 designates one of the time periods T1 and T2, to which a current time period belongs, based on the moment when the clock circuit 23 carries out the timing (Act S105).

Afterwards, the CPU 20 acquires the menu code of the recommended menu corresponding to the customer, namely the operator, from the database 5 based on the attribute designated in Act S104 and the time period designated in Act S105 (Act S106).

The processing in Act S106, for example, is realized by enabling the ordering terminal 2 and the server 1 to synergistically action. In such a condition, for example, the CPU 20 sends the attribute designated in Act S104 and the time period designated in Act S105 to the server 1 and waits the response from the server 1. When receiving the attribute and the time period, the CPU 10 of the server 1 extracts the record to which the attribute relates from one of the recommending files FA1 and FA2, which corresponds to the time period, and returns the record to the ordering terminal 2. By receiving the record returned in such a manner, the CPU 20 can acquire the menu codes corresponding to the recommended menus R1-R6.

In addition, the processing in Act S106 can be also completed in the condition of not accompanying the access to the server 1. In such a condition, for example, when the power of the ordering terminal 2 is turned on, and the like, the CPU 20 downloads the database 5 from the server 1 and stores the database 5 in the RAM 22 and the like. Afterwards, by extracting the record to which the attribute confirmed in Act S104 relates from one of the recommending files FA1 and FA2 included from the downloaded database 5, which corresponds to the time period confirmed in Act S105, the CPU 20 can acquire the menu codes corresponding to the recommended menus R1-R6.

After Act S106, the CPU 20 generates the screen data of the ordering screen 100 including the buttons 141-146 corresponding to the acquired menu codes (Act S107). Particularly, in the present embodiment, the CPU 20 configures the image and the name of the menu item to which the menu code of the recommended menu R1 relates on the button 141, configures the image and the name of the menu item to which the menu code of the recommended menu R2 relates on the button 142, configures the image and the name of the menu item to which the menu code of the recommended menu R3 relates on the button 143, configures the image and the name of the menu item to which the menu code of the recommended menu R4 relates on the button 144, configures the image and the name of the menu item to which the menu code of the recommended menu R5 relates on the button 145, and configures the image and the name of the menu item to which the menu code of the recommended menu R6 relates on the button 146. The images and the names of the menu items to which the menu codes of the recommended menus R1-R6 relates, for example, are acquired by referring to a menu master correlating the name, the price, the image and the like with the menu code of each menu item provided in the food and drink shop. The menu master can be previously stored in the ROM 21, and can be also stored in the RAM 22 after being downloaded from the server 1 by the CPU 20 when the power of the ordering terminal 2 is turned on, and the like.

After Act S107, the CPU 20 enables the display 25 to display the ordering screen 100 based on the generated screen data (Act S108).

In the state that the ordering screen 100 is displayed on the display 25 in such a manner, the CPU 20 waits the input (the confirmation of the ordering) of an ordering sending instruction generated by the operation for the ordering sending button 150 (Act S110) while accepting the ordering generated by the operation for the ordering screen 100 (Act S109).

At the moment, the operator of the ordering terminal 2 can designate the expected menu item as an ordered object by operating each button included in the category button groups 110 and 120, the menu button group 130 and the recommended menu button group 140 included in the ordering screen 100. When the menu item is designated, the CPU 20 displays a GUI for designating the ordering quantity on the ordering screen 100. The operator can designate the ordering quantity of the menu item by the operation of the GUI.

When the menu item and the ordering quantity are designated, the CPU 20 registers ordering data including the menu code of the menu item, the ordering quantity and the attribute confirmed in Act S104 in the ordering buffer of the RAM 22. Particularly, in the condition that the menu item is designated by the operations for the buttons 141-146 included in the recommended menu button group 140, the CPU 20 adds additional information denoting that the ordering is the ordering carried out from the recommended menu button group 140 to the ordering data of the menu item.

Finally, when the operator operates the ordering sending button 150 to input the ordering sending instruction (in Act S110, Yes), the CPU 20 carries out the ordering processing on the ordering data by sending the ordering data registered in the ordering buffer to the server 1 through the communication unit 24 (Act S111).

Subsequently, the CPU 20 cancels the ordering data registered in the ordering buffer (Act S112), and returns to Act S102. At the moment, if the ordering terminal 2 is not mounted on the cradle, then, the CPU 20 executes the processing in Acts S103-S112, and if the ordering terminal 2 is mounted on the cradle, the CPU 20 will be standby in Act S102. When the ordering terminal 2 is mounted on the cradle, for example, the ordering terminal 200 can be also removed, and PR information and the like related to the shop or the menu item are displayed on the display 25.

In this way, the CPU 20 of the ordering terminal 2 of the present embodiment functions as the following units: the attribute confirming unit confirming the attribute of the operator based on the operator image included in the image data generated by the camera 27; the menu confirming unit confirming the recommended menu limited for the attribute confirmed by the attribute confirming unit from the database 5; a displaying control unit displaying the ordering screen 100 including the screen component for designating the recommended menu confirmed by the menu confirming unit on the display 25; and the ordering processing unit carrying out the ordering processing on the menu confirmed by the operation for the ordering screen 100 by using the touch panel 26.

Next, the main actions of the server 1 will be described.

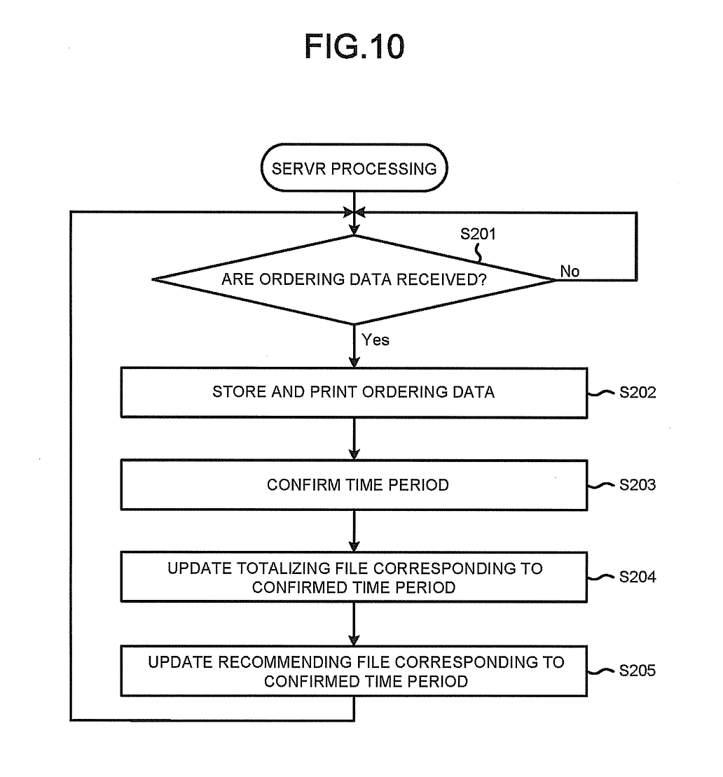

When the server 1 is started up by the operation and the like of the power switch not shown in the figures, the CPU 10 of the server 1 executes the computer program stored in the ROM 11 and the like, and begins acting according to a flow chart in FIG. 10.

In these actions, first, the CPU 10 waits the reception of the ordering data from the ordering terminal 2 (Act S201). When the ordering data sent in Act S111 are received from the ordering terminal 2 through the communication unit 14 (in Act S201, Yes), the CPU 10 stores the ordering data in the auxiliary storage apparatus 15 as the ordering data from the customer near the table provided with the ordering terminal 2 with a sending source, and moreover, instructs to carry out the printing of a slip related to the ordering data towards a kitchen printer configured in a cooking place (Act S202). A salesclerk positioned in the cooking place cooks the menu item related to the ordering data according to the slip.

After Act S202, the CPU 10 designates one of the time periods T1 and T2, to which the current time period belongs, based on the moment when the clock circuit 13 carries out the timing (Act S203).

Afterwards, the CPU 10 updates one of the totalizing files FB1 and FB2, which corresponds to the time period confirmed in Act S203, based on the menu code, the quantity, the attribute and the additional information included in the ordering data received in Act S201 (Act S204). In the condition that the additional information is added to the ordering data in the processing, the CPU 10 counts up the total ordering quantity X for the attribute included in the ordering data written in the record corresponding to the menu code included in the ordering data with the ordering quantity included in the ordering data. On the other hand, in the condition that the additional information is added to the ordering data, the CPU 10 counts up the total ordering quantity X about the attribute included in the ordering data written in the record corresponding to the menu code included in the ordering data and the recommended ordering quantity Y with the ordering quantity included in the ordering data.

After Act S204, the CPU 10 further updates one of the recommending files FA1 and FA2, which corresponds to the time period confirmed in Act S203, based on the totalizing file FB1 or the totalizing file FB2 updated in Act S204 (Act S205). In the processing, the CPU 10 refers to the total ordering quantity X related to the attribute included in the ordering data received in Act S201 to confirm the top-six menu codes of the total ordering quantity X for each record included in one of the totalizing files FB1 and FB2, which corresponds to the time period confirmed in Act S203. Afterwards, in one of the recommending files FA1 and FA2, which corresponds to the time period confirmed in Act S203, the recommended menus R1-R6 of the record related to the attribute included in the ordering data are rewritten by using the six menu codes. For example, the recommended menu R1 is rewritten as the menu code with the most total ordering quantity X in the six menu codes, the recommended menu R2 is rewritten as the menu code with the second most total ordering quantity X in the six menu codes, the recommended menu R3 is rewritten as the menu code with the third most total ordering quantity X in the six menu codes, the recommended menu R4 is rewritten as the menu code with the fourth most total ordering quantity X in the six menu codes, the recommended menu R5 is rewritten as the menu code with the fifth most total ordering quantity X in the six menu codes, and the recommended menu R6 is rewritten as the menu code with the least total ordering quantity X in the six menu codes.

In addition, in the condition that the number of the ordering data received in Act S201 is multiple, the processing in Acts S202-S205 is carried out by using each of the ordering data as the object. After the processing in Act S205, the processing of the CPU 10 is returned to Act S201.

In addition, when the customer is to leave the shop, the POS terminal 3 reads out the ordering data stored in the auxiliary storage apparatus 15 as the ordering from the customer and executes the checkout processing of the payment amount.

In this way, the CPU 10 of the server 1 of the present embodiment functions as the following units: a totalizing unit totalizing the number of times for ordering based on the ordering data received from the ordering terminal 2 through the communication unit 14 and the attribute of the operator confirmed based on the operator image included in the image data generated by the camera 27 and for the menu and each combination of the attributes of the operator; and an updating unit updating the recommended menu specified for each attribute in the database 5 based on the menu whose ordering time is higher in the totalization result of the totalizing unit related to each attribute.

As described above, the ordering terminal 2 of the present embodiment confirms the attribute of the operator based on the image data acquired by capturing the image of the customer as the operator by using the camera 27, and displays the recommended menu corresponding to the confirmed attribute on the ordering screen 100. In such a manner, the menu of the penchant of the customer, namely, the operator can be recommended.

In addition, besides considering the attribute of the operator, the ordering terminal 2 also considers the current time period to select the recommended menu, and therefore, the more suitable menu can be recommended. Particularly, by setting the time period as the time period dividing the shop hours of the shop into the plurality of ones, it's possible to correspond to the change of the penchant of the customer within the shop hours of one day.

In addition, the server 1 reflects the content of the ordering when the ordering is carried out each time, and updates the content of the database 5. Therefore, the recommended menu considering a newest ordering actual performance is stipulated in the database 5. In addition, the totalization result of the total ordering quantity X and the recommended ordering quantity Y and each menu item and each combination of the attributes are written in the database 5. If it refers to these total ordering quantity X and recommended ordering quantity Y, the effect and the like of the recommended menu button group 140 can be analyzed.

Besides that, various preferable effects are realized based on the configurations disclosed in the present embodiment.

### A Second Embodiment

The second embodiment is described.

In the present embodiment, the difference from the first embodiment lies in that the time periods T1 and T2 are set as the time periods related to elapsed time after each customer carries out the initial ordering rather than setting the time periods T1 and T2 as the time periods dividing the shop hours of the shop into the plurality of ones like the launch time and the dinner time.

Configurations of the order entry system, the configurations of the server 1, the configurations of the ordering terminal 2, configurations of the ordering screen 100 and configurations of the database 5 are the same as those in the embodiment described with reference to FIG. 1 to FIG. 8 in the first embodiment. However, the time period T1 corresponding to the recommending file FA1 and the totalizing file FB1 is set as, for example, the time period whose elapsed time is less than 1 hour after the customer carries out the initial ordering, and the time period T2 corresponding to the recommending file FA2 and the totalizing file FB2 is set as, for example, the time period whose elapsed time is more than or equal to 1 hour after the customer carries out the initial ordering.

In addition, the actions of the ordering terminal 2 and the server 1 are respectively the same as the actions illustrated in the flow charts in FIG. 9 and FIG. 10. However, in Act S105, the CPU 20 of the ordering terminal 2 confirms one of the time periods T1 and T2, to which the current time period belongs, based on the moment when the clock circuit 23 carries out the timing and the moment (hereinafter, called as reference moment t) when the customer carries out the initial ordering. For the reference moment t, for example, when the customer coming in the shop initially operates the ordering sending button 150, the CPU 20 acquires a current moment from the clock circuit 23 and stores the moment in the RAM 22. In Act S105 in which the customer carries out the initial ordering, the reference moment t is not stored in the RAM 22, but in such a condition, the current moment when the clock circuit 23 carries out the timing is regarded as the reference moment t.

In addition, on the side of the server 1, in order to confirm the time period in Act S203, the reference moment t needs to be mastered. Therefore, for example, in Act S111, besides sending the ordering data, the CPU 20 also sends the reference moment t to the server 1.

In Act S203, the CPU 10 of the server 1 confirms one of the time periods T1 and T2, to which the current time period belongs, based on the current moment when the clock circuit 13 carries out the timing and the reference moment t received from the ordering terminal 2. In the condition that the elapsed time from the reference moment t to the current moment is less than 1 hour, the current time period is the time period T1, and in the condition that the elapsed time from the reference moment t to the current moment is more than or equal to 1 hour, the current time period is the time period T2.

In addition, when the customer completes settlement by using the POS terminal 3, the server 1 notifies the completion of the settlement to the ordering terminal 2 used by the customer. When the notification is received, the ordering terminal 2 cancels the reference moment t stored in the RAM 22.

In the condition that the time periods T1 and T2 are set like the present embodiment, the appropriate menu item considering the elapsed time after the customer carries out the initial ordering can be recommended.

Besides that, based on the configurations disclosed in the present embodiment, the configurations described in the first embodiment are also included, and moreover, the various preferable effects are realized.

### Modified Example

The configurations disclosed in the first embodiment and the second embodiment can be appropriately modified for implementation.

For example, a pattern except the three patterns of the male, the female and the child can be also adopted as the attribute of the customer. For example, the attribute of a more detailed age category like under 10 years old, above 10 years old but under 20 years old, above 20 years old but under 30 years old . . . , can be also adopted, or the attribute related to a matter except the age and the gender, such as the physique (height or weight and the like) of the customer, and all that, can be added.

In addition, the time period in the first embodiment and the second embodiment is not limited to the time periods T1 and T2, and more time periods T1, T2 . . . Tn (n being an integer and n being not less than 3) can be also set. In the condition that the quantity of the time periods is increased in such a manner, recommended menu files FA1-FAn and totalizing files FB1-FBn corresponding to each of the time periods T1-Tn are set in the database 5.

In addition, in the first embodiment and the second embodiment, the computer program for realizing the processing in FIG. 9 and FIG. 10 is stored in the ROM 11 and the ROM 21. However, it is not limited to that, a similar program can be also downloaded in the server 1 or the ordering terminal 2 from a network, or the similar program recorded in a storage medium can be also installed in the server 1 or the ordering terminal 2. For a recording medium, so long as it is an apparatus which can store the program, and furthermore, is apparatus-readable, like a CD-ROM, a memory card and the like, its form is not limited. In addition, functions acquired by the installation or the downloading of the program can be also realized by synergistically acting with the OS and the like inside the apparatus.

In addition, the server 1 can be also enabled to execute one portion set as the processing executed by the ordering terminal 2, or the ordering terminal 2 is enabled to execute the portion set as the processing executed by the server 1. For example, the image data generated in Act S103 can be also sent to the server 1 from the ordering terminal 2, the processing in Acts S104-S107 is executed in the server 1, the screen data generated in such a manner are sent to the ordering terminal 2 from the server 1, and the display 25 is enabled to display the ordering screen 100 based on the screen data in Act S108.

In addition, various kinds of the processing can be also realized by utilizing cloud computing. In such a condition, for example, a cloud comprising a plurality of servers is connected with the order entry system in a communication manner, and the cloud is enabled to share in the portion set as the processing executed by the server 1 or the ordering terminal 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ordering terminal, comprising:
an image capturing unit configured to capture the image of an operator to generate image data;
an attribute confirming unit configured to confirm the attribute of the operator based on an operator image included in the image data generated by the image capturing unit;
a menu confirming unit configured to confirm a recommended menu specified for the attribute confirmed by the attribute confirming unit from a database specifying the recommended menu for each attribute of the operator;
a displaying unit configured to display an ordering screen including a screen component for designating the recommended menu confirmed by the menu confirming unit;
an operating unit configured to operate the ordering screen; and
an ordering processing unit configured to carry out ordering processing on the menu designated by the operation of the ordering screen by the operating unit.

2. The ordering terminal according to claim 1, wherein
the recommended menu is specified for each combination of the attribute of the operator and a time period in the database; and
the menu confirming unit confirms the recommended menu specified for the combination of the attribute confirmed by the attribute confirming unit and the time period to which a current moment belongs.

3. The ordering terminal according to claim 1, wherein
the time period is a time period dividing the shop hours of a shop into a plurality of ones.

4. The ordering terminal according to claim 2, wherein
the time period is a time period dividing the shop hours of a shop into a plurality of ones.

5. The ordering terminal according to claim 1, wherein
the time period is a time period related to elapsed time after the operator as a customer carries out initial ordering.

6. The ordering terminal according to claim 2, wherein
the time period is a time period related to elapsed time after the operator as a customer carries out initial ordering.

7. A ordering method, comprising:
capturing the image of an operator to generate image data;
confirming the attribute of the operator based on an operator image included in the generated image data;
confirming a recommended menu specified for the confirmed attribute from a database specifying the recommended menu for each attribute of the operator;
displaying an ordering screen including a screen component for designating the confirmed recommended menu; and
carrying out ordering processing on the menu designated by the operation of the ordering screen.
